(19) United States
(12) Patent Application Publication
(10) Pub. No.: US 2005/0114520 A1
(43) Pub. Date: May 26, 2005

(54) Access to foreign network resources

(76) Inventors: Craig White, Eagle, ID (US); John Gomes, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/719,442

(22) Filed: Nov. 21, 2003

(51) Int. Cl. G06F 15/16

(52) U.S. Cl. 709/228

(57) ABSTRACT

A network resource access system having a network resource coupled with a network behind a network firewall. The system includes a web services router coupled with a network accessible outside of a firewall protecting the network, and a web services request generator external to the firewall of the network configured to communicate with the web services router, wherein the web services request generator is configured to generate a web services request containing content and send the web services request to the web services router for access to the network resource.

### BACKGROUND

Recent years have seen a proliferation of portable electronic devices, such as personal digital assistants (PDA's), cellular telephones, laptop computers, and other portable electronic devices. These devices may offer a variety of capabilities including scheduling calendars, contact information, task lists, email applications, pager functions, cellular telephone capabilities, wireless internet access, etc.

Situations may arise where critical data or hardcopy documents may not be available because of the limitations of a portable electronic device. For example, a user of a portable device may find himself in a situation where he is standing in front of a printer or network projector at a client site with his personal digital assistant in hand, and yet is unable to print to the printer or present on the projector because of a lack of connectivity between the printer or projector and the personal digital assistant, or because of network security restrictions.

### BRIEF DESCRIPTION OF THE DRAWINGS

FIG. 1 is a schematic representation of a network environment configured to implement an embodiment of the invention.

FIG. 2 is a schematic diagram illustrating security/accessibility zones of a network environment configured to implement an embodiment of the invention.

FIGS. 3A and 3B are a flow chart illustrating a method of accessing a network resource on a foreign network according to an embodiment of the invention.

### DETAILED DESCRIPTION

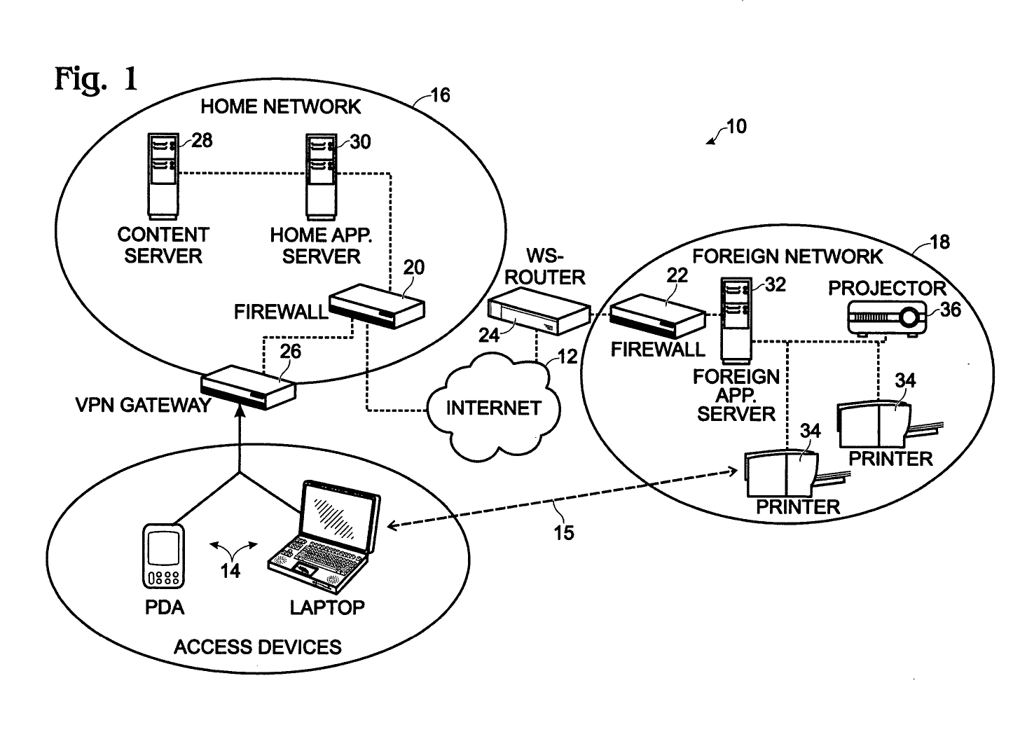

A network environment for mobile access to foreign network resources is shown in FIG. 1, and is generally indicated at 10. As shown, network environment 10 includes a plurality of components that may interact in multiple ways to accomplish mobile access to foreign network resources. Initially, the physical components of network environment 10 will be discussed followed by a discussion of the operation of the network environment to effect mobile access to foreign network resources within network environment 10.

Network environment 10 includes a wide area network 12, a mobile device 14, a home network 16, and a foreign network 18. Wide area network 12 may be, for example, the Internet. Mobile device 14 may include, for example, a cellular telephone, a personal digital assistant, laptop computer, or other mobile device. FIG. 1 shows two exemplary mobile devices 14, a laptop computer and a personal digital assistant (PDA). Mobile device 14 may be configured to act as a web services request generator. An arrow 15 indicates that mobile device 14 may be located physically proximate to a component of foreign network 18. Home network 16 and foreign network 18 may include any one of a number of network technologies. For example, networks 16 and 18 may use a peer-to-peer architecture, a ring architecture, a star architecture, a bus architecture, or other network configurations. It should be noted that foreign network 18 may be referred to as a target network.

Mobile device 14 may be configured to access home network 16 through the use of a virtual private network (VPN), or similar network gateway. Typically, home network 16 will be configured to allow authorized users, such as employees of the entity that owns home network 16, to access the home network with some telecommunications solution. Any suitable secure remote network solution may be used as those skilled in the networking arts will understand.

Home network 16 and foreign network 18 may be coupled to network 12 for communicating data therebetween. Home network 16 may include a home firewall 20 for insulating home network 16 from unauthorized access via network 12. Similarly, foreign network 18 may be insulated from unauthorized access via network 12 by a foreign firewall 22. Both firewalls 20 and 22 may be any suitable system designed to prevent an unauthorized user from gaining access to or from a private network.

Firewalls 20 and 22 may be implemented using hardware, software, or combinations of both hardware and software. Typically, firewalls may be used to prevent unauthorized Internet users from accessing intranets, or private networks, connected to the Internet, or another public WAN. Typically, all messages entering or leaving the intranet pass through the firewall, which examines each message and blocks those that do not meet specified security criteria. Firewalls 20 and 22 may employ various security techniques including packet filtering, application gateways, circuit-level gateways, proxy servers, etc.

A web services router 24 may be interposed foreign firewall 22 and network 12 to process web-based applications, or web services. Web services router 24 may be a separate hardware component connected to foreign network 18, or it may be a software component residing in the same hardware component that houses foreign firewall 22. Web-based applications, or web services may include applications using the XML, SOAP, WSDL and UDDI open standards over an Internet protocol backbone. For example, a web-based print application may be configured to allow a print job to be sent over network 12 to be printed to a printer located within foreign network 18. The print application may use XML, SOAP, WSDL, and UDDI to process the print job and transmit it over network 12.

Web services router 24 enables communications of specific formats to selectively penetrate foreign firewall 22. The web services router may provide a standardized method of integrating web-based (or network based) applications as a way to allow different organizations to communicate data between their respective networks, without knowledge of the other's network configuration.

Home Network 16 may include a virtual private network (VPN) gateway 26, or similar system, to enable remote user-login to home network 16. For example, Citrix MetaFrame Access Suite, or PC Anywhere remote access solutions, or any other commonly known remote access system, may be used to access home network 16 via gateway 26. Typically, mobile device 14 uses the VPN gateway to connect with home network 16. Home network 16 may include a content server 28 and a home application server 30. VPN gateway 26 provides for secure communications between an authorized user and the resources and components of home network 16. Typically, a VPN gateway enables secure transporting of data over the Internet, or other WAN, through the use of encryption and other security mechanisms. Thereby allowing remote users (i.e. users not connected to an intranet at a point behind a firewall) access to the intranet, without data being intercepted by a third party.

Content server 28 may be any type of file server configured to store data files of any type. Typically, content server 28 stores data accessible to users of home network 16. It will be understood that content server 28 may be a traditional file server platform, or other data storage platforms. Content server 28 may act as a web services request generator. For example, in the context of a web services print job application, content server 28 may generate a web services request including: a selected destination, content to be printed, and security credentials. The selected destination may include foreign network 18 and a printer resource, such as printer 24, attached thereto. The content to be printed may be a document. The security credentials may include a statement identifying the individual identity of sender of the request, a statement identifying any organizational affiliation, and an encryption standard.

Home application server 30 is a network server configured to perform network applications to achieve various network application functions. For example, home application server 30 may provide printing applications, such as rendering source documents to a destination printer in a printer ready format to perform printing functions. Another example of an application performed by home application server 30 is rendering multimedia presentations into a projector readable format to perform projector presentation functions. Home application server 30 may act as a web services request generator, as described above with reference to content server 28.

In addition to foreign firewall 22 and WS router 24, foreign network 18 may include a foreign application server 32. Like home application server 30, foreign application server 32 may render printer-readable data, may render projector-readable data, and/or may be configured to perform other network applications. Foreign application server 32 may perform routing functions, such as sending print jobs, or other content, to network resources. Another network application may be verifying security credentials. Foreign network 18 may include one or more printers 34 and/or one or more projectors 36. Printers 34 and projector 36 are examples of network resources. A network resource may include a wide variety of hardware, software, and peripherals.

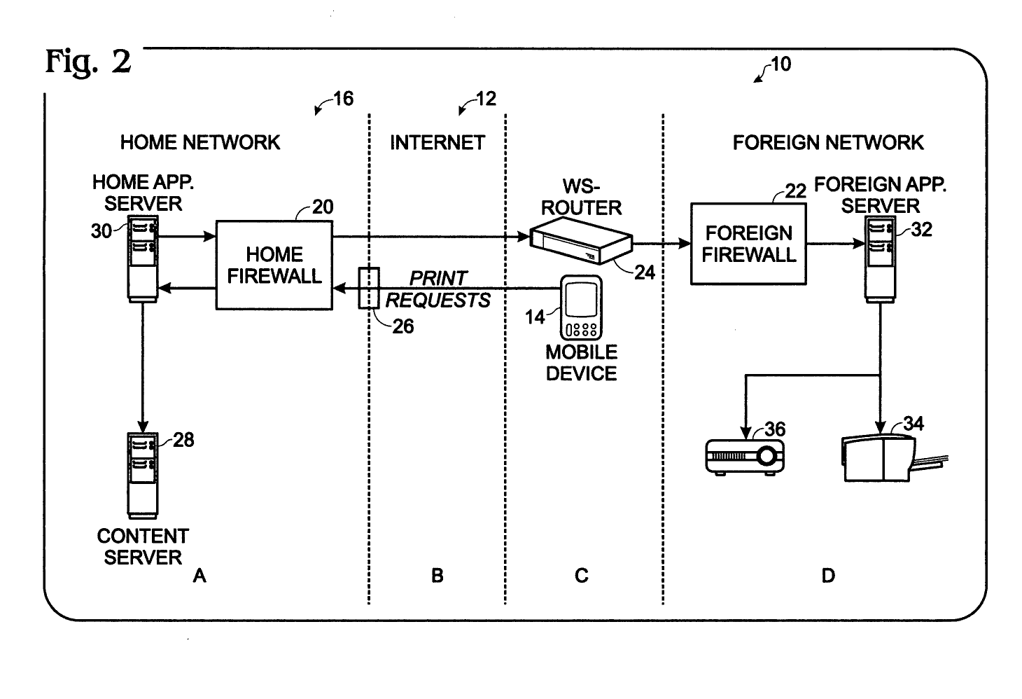

FIG. 2 is a schematic diagram illustrating security/accessibility zones of network environment 10. The diagram of FIG. 2 thus illustrates zones with different levels of access or security. Home network 16, for example, resides in a zone, defined generally by the letter A, that limits access to the components and resources of home network 16. Only users on network computers behind firewall 20, or authorized users who access home network 16 via VPN gateway 26, or some suitable remote access solution, can access components or resources in zone A. Firewall 20 separates zone A from network 12, which resides in zone B of FIG. 2. Zone B does not restrict access to any of its components. Typically, zone B includes the Internet, or a similar WAN. A buffer zone, zone C, couples with foreign network 18, but the components that reside in zone C, while coupled with foreign network 18, are outside of the protection of foreign firewall 22. Mobile device 14 may reside in either zone C, or zone B. As shown in FIG. 2, mobile device 14 resides in zone C. Finally, foreign network 18, which is protected by foreign firewall 22, defines zone D. Only users behind foreign firewall 22 may directly access the network resources of foreign network 18, such as printers 34 or projectors 36. Limited access to specific foreign network resources may be available through web services router 24, as will be explained below.

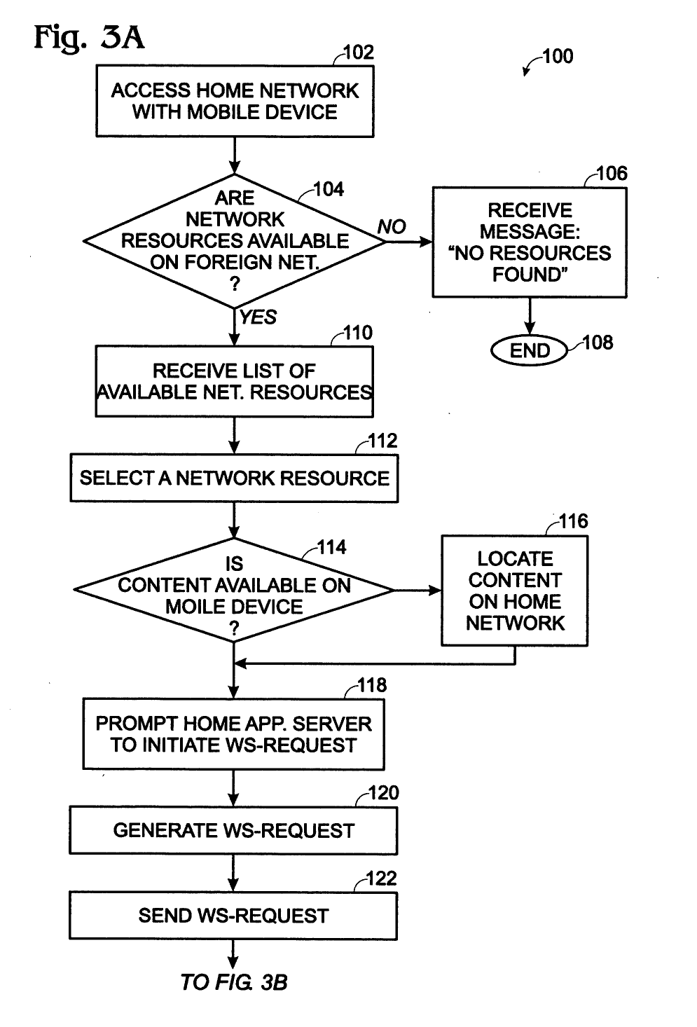

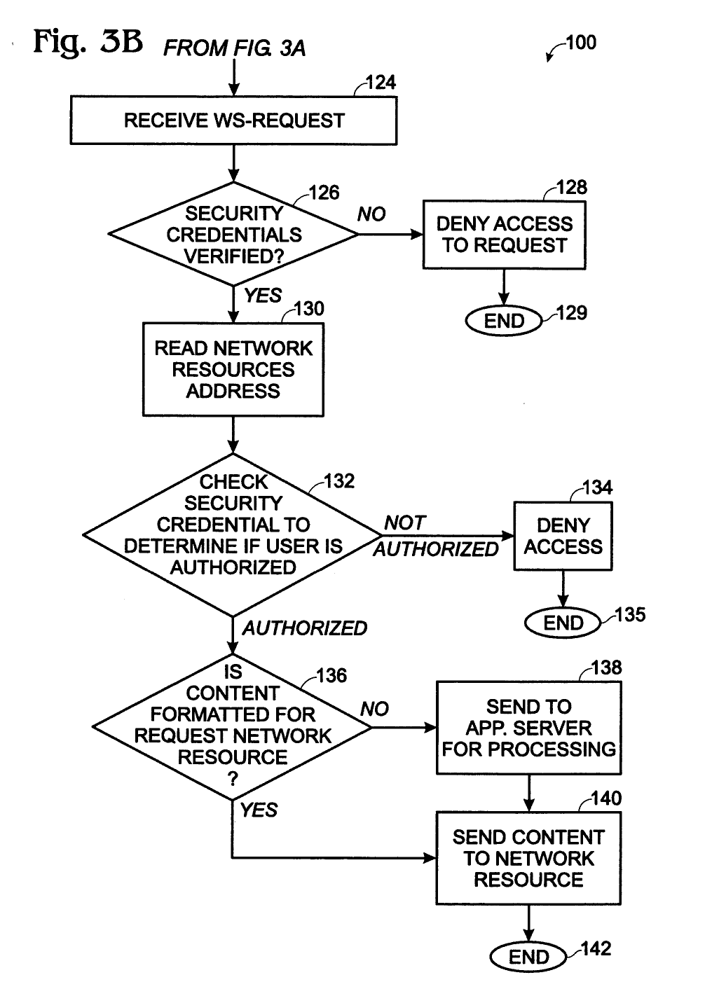

In operation, a registered user of home network 16, who is physically located adjacent foreign network 18, may use mobile device 14 to access network resources of foreign network 18 through a series of operations, as will be described with reference to method 100 of FIGS. 3A and 3B, and with reference to the physical components described above and shown in FIGS. 1 and 2.

As shown in FIG. 3A, the user of mobile device 14 connects to home network 16 via VPN gateway 26, or some other suitable remote access solution, as indicated at 102. The user's connection to home network 16 may be achieved using any suitable communication technology including a dial-up connection, a high-speed Ethernet connection, a wireless connection, or any similar network access. For example, the user may have wireless network access to the Internet via a wireless access point located in security/accessibility zone C of FIG. 2.

A user of mobile device 14 may desire to send specific content to a network resource of foreign network 18. To do so, the user may begin by performing a discovery operation on foreign network 18 to find out what resources are available for the user to access remotely, as indicated at 104. If no network resources are available, then the mobile device may receive a message indicating that no network resources were found, as indicated at 106. If no resources are found, then method 100 may end, as indicated at 108.

Discovery operations used in determining if network resources are available may include: Bluetooth® short range radio frequency discovery, infrared discovery, radio frequency identifier tag based discovery, and Internet protocol to latitude longitude discovery. The later is a mechanism to determine the location of a device based on the device's IP address.

Any of the aforementioned discovery operations may identify available network resources or devices on foreign network 18, and may provide the mobile device with the IP address, or other naming convention, that may be used to route messages containing data and/or content to the network resource on foreign network 18. In addition to the automated discovery processes listed above, the user may also enter a known device address or name manually. For example, the user may be standing near a printer that has a sign identifying the printer as “Curly,” which may be an alias that can be used to route print jobs to the printer. The user may simply use the name “Curly” to identify the printer as the network resource that the user would like to access.

Upon determining which resources are available, mobile device 14 may receive a list of available network resources after they have been discovered using one of the above-described processes, as indicated at 110. For example, the discovery process may have uncovered the following network resources: a network projector named “Conference Room 1,” a color printer named “Color 5,” and a high volume printer named “Speedy 35.” The mobile device may present a list composed from the discovered network resources.

A user of mobile device 14 may scroll, or otherwise navigate, a list containing: “Conference Room 1”, “Color 5”, and “Speedy 35,” and select a network resource from the list, as indicated at 112. Or, as noted above, if the network address or identity is known to the user, the user may enter the network address or identity manually, and thereby select the network resource located on the foreign network 18, as indicated at 112.

The user of mobile device 14 may determine if the content that the user wants to deliver to the selected network resource is located on the mobile device, as indicated at 114. If the content is not available on the mobile device, then the user may search for the desired content stored on a component of home network 16, as indicated at 116. The desired content may be stored on content server 28, or any other suitable component of home network 16.

The user of mobile device 14 may prompt home application server 30, on the home network 16, to initiate a web services request for access to the selected network resource, as indicated at 118. Home application server 30, on home network 16, may generate a web services request based upon the prompt from mobile device 14, as indicated at 120. The web services request may include a web services routing address for locating web services router 24, which is coupled with foreign network 18, and for enabling the web services request to be sent to the web services router over network 12. The web services routing address for the foreign network may be known to the user of the mobile device, or may be determined during the discovery process.

The web services request may include a network resource address, or name, which may be read by web services router 24. The web services request may include a security credential, which may include a statement defining the user of the mobile device, the users organization, as well as other security related information, such as encryption keys, etc. Additionally, the web services request may include the content for delivery to the network resource. It will be understood that any suitable components of system 10 that reside outside of foreign firewall 22, may generate the web service request.

The generated web services request may be generated to comply with W3C's XML Protocols standards which use XML, SOAP, WSDL, and UDDI open standards over an Internet protocol backbone, such as SMTP, MIME, HTTP, etc. XML, or Extensible Markup Language, is a specification designed to enable the creation of customized tags for enabling definition, transmission, validation, and interpretation of data between applications and organizations. SOAP, or Simple Object Access Protocol, is an XML-based messaging protocol used to encode the information in request and response messages for sending them over a network. SOAP message are independent of any operating system or protocol and may be transported using a variety of Internet protocols, including SMTP, MIME, and HTTP. WSDL, or Web Services Description Language, is an XML-formatted language used to describe Web Services' capabilities as collections of communication endpoints capable of exchanging messages. UDDI, or Universal Description, Discovery and Integration is a web-based distributed directory that enables businesses to list themselves on the Internet or other WANs and discover each other, similar to a traditional phone book.

The generated web services request may be forwarded to web services router 24 coupled with foreign network 18, as indicated at 122. The web services request may be transported, as described above with a variety of Internet protocols.

FIG. 3B illustrates method 100 from the perspective of web services router 24. Web services router 24 may receive the web services request, as indicated at 124 in FIG. 3B. The web services request comes from outside of firewall 22. The web services request may be generated by any web services request generator, including the home application server, mobile device, or other suitable device. Upon receipt of a web services request, the aforementioned security credential may be verified, as indicated at 126. Verifying a security credential may include reading a security token that contains statements and checking those statements against a signature. Additionally, verifying a security credential may include decrypting data using a public key type encryption system, as is commonly known.

If the security credential cannot be verified, access to the foreign network, as well as the selected network resource, may be denied, as indicated at 128. If access is denied method 100 may end, as indicated at 129. If the security credential is verified, the web services router may read the address of the selected resource, as indicated at 130. The address of the selected network resource may be encrypted, such that only after verification or authentication of the security credential, can the address be read.

The process of receiving a web services request and verifying the security credential may be viewed as analogous to receiving a message contained inside two nested envelopes. An outer envelope may be addressed to deliver the message to a recipient organization (analogous to the address of web services router on the foreign network). This outer envelope contains a return address or seal identifying the sender of the message (analogous to the security credentials). Provided the seal or return address is acceptable to the recipient organization, the outer envelope is opened to reveal the inner envelope addressed to an individual of the recipient organization (analogous to decrypting the selected network resource address).

The web services router may check an access list configured to restrict access to network resources on foreign network 18, as indicated at 132. The access list may be stored on foreign application server 32, or another component of foreign network 18. It also should be noted that a secure server external to foreign network 18 may maintain the access list. The access list may enable foreign network 18 to selectively allow access to various network resources to individual users, or groups of users, thereby providing a versatile security access system for external users. For example, some network resources may be available to customers that visit the foreign network regularly, while other network resources may not be available. This system may be scalable and adaptable to meet the needs of a foreign network by permitting some access to network resources, but protecting other resources. An external user may be any user that does not have a profile or log on account with the private network, in this example a client visiting foreign network 18.

If the user verified by the security credential contained in the web services request is not authorized by the access list to have access to the selected network resource, the user may be denied access to the network resource, as indicated at 134. If the user is denied access, method 100 may end, as indicated at 135. Access list may be configured to enable individual people access to network resources, or may grant access to network resources to groups of users. For example, if foreign network 18 allows all users authenticated as employees of an important vendor, the access list may be configured to allow all of the vendor's employees to have access to a set of network resources.

If the user is authorized to access the selected network resource, the content data of the web services request may be checked to determine if it is properly formatted for the selected network resource, as indicated at 136. For example, where the selected network resource is a printer, the format of the content data may be checked, to determine if it is readable by the selected printer.

If the content data is not formatted for the selected network resource, the web services router may forward the content data and associated information from the web services request through the firewall to foreign application server 32 for processing, as indicated at 138. Processing of the content data by the foreign applications server may include, for example, rendering content into printer readable format, converting data between formats, etc.

If the content data is in the proper format for the network resource, or after the content data has been rendered in the proper format for the network resource, the content may be sent, through the firewall if necessary, to the selected network resource by the web services router, as indicated at 140. Typically, web services router 24 generates a network resource call that includes the content data and a destination address associated with the selected, or identified, network resource. As noted above the destination address may be decrypted after a security credential has been verified. The network resource call may be formatted for transmission through foreign firewall 22.

The selected network resource may then use the content data. For example, if the content data is a document for printing and the selected network resource is a printer, the printer may produce a hard copy of the document. If, for example, the content data is a multimedia presentation and the selected network resource is a projector, the projector may present the presentation.

Once the user has accessed the selected network resource method 100 may conclude, as indicated at 142. As noted above, method 100 may conclude at 108, if no network resources are available. Additionally, method 100 may conclude at 129, or 135 if access to the selected network resource has been denied.

While the present disclosure has been made with reference to the foregoing preferred embodiments, those skilled in the art will understand that many variations may be made therein without departing from the spirit and scope defined in the following claims. The disclosure should be understood to include all novel and non-obvious combinations of elements described herein, and claims may be presented in this or a later application to any novel and non-obvious combination of these elements.

1. A network resource access system having a network resource coupled with a network behind a network firewall comprising:
a web services router coupled with a network accessible outside of a firewall protecting the network; and
a web services request generator external to the firewall of the network, the web services request generator being configured to generate a web services request including request content and configured to send the web services request to the web services router, which selectively passes the request content to the network resource.

2. The network resource access system of claim 1, further comprising a mobile device external to the firewall of the network configured to prompt the web services request generator to generate a web services request and configured to provide the web services request generator with a routing identifier for the network resource.

3. The network resource access system of claim 2, wherein the mobile device performs a discovery operation to obtain the routing identifier of the network resource.

4. The network resource access system of claim 3, wherein the discovery operation is selected from the group including short-range radio frequency discovery, infrared discovery, radio frequency identifier tag based discovery, Internet protocol to latitude longitude discovery, and manual discovery.

5. The network resource access system of claim 1, wherein the request content includes image data.

6. The network resource access system of claim 1, wherein the web services request includes a routing identifier having a first address configured to route the request to the web services router and a second address configured to route the request content to the network resource.

7. The network resource access system of claim 6, wherein the web services router is configured to process the web services request by translating the request content into a communications protocol and by forwarding the translated request content through the firewall to the network resource.

8. The network resource access system of claim 7, wherein the web services request includes at least one security credential, and wherein the web services router is configured to verify the at least one security credential, and selectively forward the translated request content to the network resource based on the at least one security credential.

9. The network resource access system of claim 8, wherein the web service router is configured to verify the at least one security credential by comparing the security credential to a list of authorized users.

10. The network resource access system of claim 7, wherein the communications protocol includes Simple Object Access Protocol (SOAP).

11. The network resource access system of claim 10, wherein the communications protocol includes at least one security credential.

12. The network resource access system of claim 1, wherein the request generator is resident on a system component selected from the group including: a mobile device, a home application server, and a content server.

13. The network resource access system of claim 1, wherein the network resource is a printer.

14. The network resource access system of claim 1, wherein the network resource is a projector.

15. The network resource access system of claim 1, further comprising a foreign application server coupled with the network behind the firewall and configured to perform one or more network application functions.

16. The network resource access system of claim 1, further comprising a foreign application server coupled with the network behind the firewall and configured to perform one or more network application functions, wherein the one or more network application functions are selected from the group including rendering print content into printer readable format, verifying security credentials, routing translated content to the network resource, rendering projector content into projector readable format, and combinations thereof.

17. The network resource access system of claim 13, wherein the web services router forwards the request content to the foreign application server for processing by the one or more network application functions.

18. A method of accessing a network resource within a target network from outside a firewall of the target network, the method comprising:
receiving a web services request to access the network resource from outside the firewall of the target network, wherein the web services request includes request content and a network resource identifier; and
selectively authorizing the request content to penetrate the firewall of the target network to access the identified network resource.

19. The method of claim 18, further comprising:
generating a network resource call including the request content and a destination address derived from the network resource identifier; and
sending the network resource call through the firewall to the destination address.

20. The method of claim 19, wherein receiving the request to access a network resource includes receiving the web services request in XML using a Simple Object Access Protocol.

21. The method of claim 18, wherein receiving the web services request includes receiving a security credential.

22. The method of claim 21, wherein selectively authorizing the request content to penetrate the firewall includes authenticating a security credential and authorizing the request content to penetrate the firewall upon the security credential being authenticated.

23. The method of claim 22, wherein authenticating the at least one security credential includes matching the at least one the security credential to a user on a list of authorized users.

24. A method of accessing a foreign network resource by a mobile device external to the foreign network, the method comprising:
accessing a home network by a mobile device;
selecting a foreign network resource; and
initiating a web services request for access to the selected foreign network resource.

25. The method of claim 24, further comprising discovering at least one foreign network resource.

26. The method of claim 24, wherein discovering at least one foreign network resource includes using a discovery operation selected from the group including short-range radio frequency discovery, infrared discovery, radio frequency identifier tag based discovery, Internet protocol to latitude longitude discovery, and manual discovery.

27. The method of claim 26, further comprising providing a list of network resources to the mobile device, wherein selecting a foreign network resource includes selecting from the list provided to the mobile device.

28. The method of claim 24, wherein initiating a web service request includes prompting an application server on the home network to generate a web service request, wherein the web service request includes request content for delivery to the selected foreign network resource.

29. The method of claim 24, further comprising instructing the application server to deliver the request content to the selected foreign network resource.

30. A media storage device including instruction for accessing a network resource within a target network from outside a firewall of the target network, the instructions comprising instructions to:
receive a web services request to access the network resource from outside of the firewall of the target network, wherein the web services request includes request content and a network resource identifier; and
selectively authorize the request content to penetrate the firewall of the target network to access the identified network resource.

31. The media storage device of claim 30, further including instructions to:
generate a network resource call including the request content data and a destination address derived from the network resource identifier; and
send the network resource call through the firewall to the destination address.

32. The media storage device of claim 30, wherein instructions to receive the web services request include instructions to receive the web services request in XML using a Simple Object Access Protocol.

33. The media storage device of claim 30, wherein instructions to receive the web services request include instructions to receive a security credential.

34. The media storage device of claim 33, wherein the instructions to selectively authorize the request content to penetrate the firewall include instructions to authenticate a security credential and instructions to authorize the request content to penetrate the firewall upon the security credential being authenticated.

35. The media storage device of claim 34, wherein the instructions to authenticate the at least one security credential include instructions to match the at least one security credential to a user on a list of authorized users.

36. A media storage device including instructions to access a foreign network resource from a mobile device external to the foreign network, the instructions comprising instructions to:
access a home network from a mobile device;
select a foreign network resource; and
initiate a web services request for access to the selected foreign network resource.

37. The media storage device of claim 36, further including instructions to discover at least one foreign network resource.

38. The media storage device of claim 36, wherein instructions to discover at least one foreign network resource include instructions to use a discovery operation selected from the group including: short-range radio frequency discovery, infrared discovery, radio frequency identifier tag based discovery, Internet protocol to latitude longitude discovery, and manual discovery.

39. The media storage device of claim 36, wherein instructions to initiate a web service request include instructions to prompt an application server on the home network to generate a web service request, wherein the web service request includes request content for delivery to the selected foreign network resource.

40. The media storage device of claim 39, further including instructions to instruct the application server to deliver the request content to the selected foreign network resource.

41. A network resource access system having a network resource coupled with a network behind a network firewall comprising:
a means for processing web services communications coupled with a network accessible outside of a firewall protecting the network; and
a means for generating a web services request external to the firewall of the network configured to communicate with the means for processing web services communications, wherein the means for generating a web services request is configured to generate a web services request containing content and send the web services request to the means for processing web services communications, wherein the request seeks access to the network resource.
